(19) United States
(12) Patent Application Publication
(10) Pub. No.: US 2016/0150281 A1
(43) Pub. Date: May 26, 2016

(54) VIDEO-BASED USER INDICIA ON SOCIAL MEDIA AND COMMUNICATION SERVICES

(71) Applicant: Vervid, Inc., San Jose, CA (US)

(72) Inventors: John Whaley, San Jose, CA (US); Daniel Proksch, San Jose, CA (US)

(73) Assignee: Vervid, Inc.

(21) Appl. No.: 14/920,638

(22) Filed: Oct. 22, 2015

Related U.S. Application Data
(60) Provisional application No. 62/069,302, filed on Oct. 27, 2014.

(51) Int. Cl. H04N 21/4788; H04N 21/235; H04N 21/439; H04N 21/233; H04N 21/472; H04N 21/2743; H04N 21/234

(52) U.S. Cl. CPC H04N 21/4788; H04N 21/2743; H04N 21/2353; H04N 21/23418; H04N 21/233; H04N 21/47217; H04N 21/4396

(57) ABSTRACT

A video-based user indicia is provided for use in social media networks or other communication services. A user uploads or otherwise designates a video clip for use as user indicium on the service. Content from the video clips is displayed as a user indicium proximate content items generated by, or associated with, the user. The video content may be initially displayed as a frame from the associated video clip, with video playback initiated by user selection of the indicia. The video content may play automatically upon rendering on a user's display. The video content may be looped. The video content may include audio content, which may be played back immediately upon initiation of video playback, or toggled on and off by user selection of the indicia. A user may maintain a library of multiple video clips for selection as a user indicia, either universally across the platform or in connection with a specific content item.

### TECHNICAL FIELD

Embodiments of the present disclosure relate in general to user indicia on social media and other electronic communication services, and in particular to computer-implemented systems and methods to utilize video content as a user indicium.

### BACKGROUND

In recent years, social media services and other online communication services have become increasingly important avenues for human expression and communication. For many individuals, online platforms have become a primary method by which they communicate. Such services include, without limitation, Facebook®, Youtube®, Google+®, Instagram®, Snapchat®, online forums and chatrooms.

Such services commonly enable users to configure a profile picture as a customizable user indicium to identify a user. The profile picture is typically uploaded to the service by a user, and/or selected from amongst a plurality of preconfigured options. Commonly, individuals utilize a portrait photograph as a profile picture. The profile picture is then used within the communication service as an indicium for the user. For example, in a social media service, a user profile picture may be presented adjacent to content contributions by the associated user, thereby providing an indication of content source to other users. In an instant messaging service, a user profile picture may be displayed adjacent to messages authored by the associated user, again providing an indication of content source.

The content and composition of profile pictures are commonly considered to convey important information about an individual to other users. Accordingly, users often place great significance on the content and composition of profile pictures utilized within social media and other online communication services. Selecting and using a user indicium that communicates a desired impression of the user is important, yet challenging, for many users.

### SUMMARY

The present disclosure describes, inter alia, systems and methods for social media and other online communication platforms in which users can use video content as a user indicium, i.e. a video profile picture. The video-based user indicium can serve as a unique indicator or representation of a user on an online platform, such as social media. The video-based user indicium can be rendered proximate user-generated and/or user-associated content.

In accordance with one aspect, the system can be implemented on one or more network-connected servers communicating with a plurality of user devices via a digital communications network, which may include the Internet. Content can be presented via, e.g., a web browser, or a locally-installed application such as a mobile app.

In accordance with one aspect, a profile video clip is received by the servers from a first user device used by a first user. The profile video clip is associated with the first user. Data is transmitted to one or more user devices associated with viewing users. The data enables display by the user devices of a user indicium for the first user comprising the profile video clip. The user indicium may be displayed proximate content generated by, or associated with, the first user.

The profile video clip may include both audio and video content. The profile video clip may be initially displayed as an image extracted from the profile video clip and displayed within a frame. Playback of the profile video clip within the frame may be initiated by a user having selected the user indicium, such as by tapping or clicking a display area in which the user indicium is displayed. In other cases, playback of the profile video clip may be initiated automatically, such as immediately upon first rendering of the user indicium on a viewing user's display. When profile video playback is initiated automatically, it may be initially played back without sound; in which case, the user may be able to initiate playback of the profile video audio content by selecting the user indicium. In some embodiments, audio content may be toggled on and off by repeatedly tapping, clicking or otherwise selecting the user indicium. The profile video may be played back in a looped fashion, such that it repeats multiple times or indefinitely.

In accordance with another aspect, the user indicium may include an integrated playback progress indicator. The playback progress indicator may include a progress bar rendered around the perimeter of a user indicium. In some embodiments, the user indicia may be circular in shape. In some embodiments, the user indicia may be rendered on top of content generated by, or otherwise associated with, the corresponding user.

In accordance with another aspect, a user may be associated with a library comprising multiple video clips. The user may be permitted to select a different profile video for display by default in association with that user's content. The user may be permitted to select a different profile video for display in association with a particular item of user-generated or user-associated content.

In accordance with other aspects, methods for displaying content items in a social networking service or online communication service are provided. In accordance with yet other aspects, social networking systems and online communication systems are provided, in which user indicia may include video content.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is a schematic block diagram of a computing environment.

FIG. 2 is a schematic block diagram of a user computing device.

FIG. 3 is a flow chart of a process for generating video-based user indicia.

FIG. 4 is a user interface for generating video-based user indicia.

FIG. 5 is a user interface display with video-based user indicia.

FIG. 6 is a flow chart for presenting video content in a user indicium.

FIG. 7A-7F are sequential images of a video-based user indicium with integrated playback progress indicator.

FIG. 8 is a user interface display with video-based user indicium and in-place playback progress indicator.

FIG. 9 is an alternative embodiment of a user interface display with video-based user indicia.

FIG. 10 is a flow chart of a process for associating video-based user indicia with user-generated or user-associated content.

FIG. 11 is a flow chart of a process for use of video-based user indicia in a social networking service.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

From the perspective of its end users, the value of a social media or online communication platform depends significantly on multiple factors. Amongst those factors may be how well a user can convey a desired impression of themselves on the platform, and how readily a user can perceive an impression of other users on the platform. Platforms in which users can readily identify other users generating content of interest may promote greater network building amongst users, driving more content generation and greater usage. Accordingly, features and capabilities that promote rich and rapid communication of user characteristics and personality may be valuable to users and system operators alike.

One mechanism that may provide such benefits is video profile pictures, i.e. use of video content to serve as user indicia, in place of static profile images. Video-based user indicia may also include audio content, and may be utilized in, amongst other use cases, any scenario in which static profile images have been used, including on a profile page, overlaid on or near user-generated content (such as shared videos or text comments) or user-associated content (such as user activity notifications), and in other use cases, as described hereinbelow.

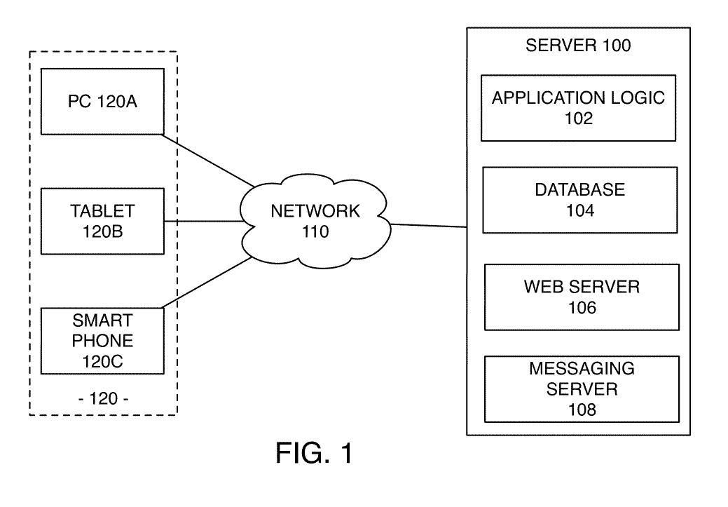

FIG. 1 is schematic block diagram of an embodiment of an online communication platform, such as a social media service. Server 100 communicates, inter alia, via computer network 110, which may include the Internet, with user devices 120 such as personal computer 120A, tablet computer 120B and smart phone 120C. While certain illustrated embodiments are implemented using smartphones, tablets or other mobile devices as user devices, it is contemplated and understood that embodiments may also be used with personal computers and any other device that a user may use to access social media or other digital communication services.

Server 100 implements application logic 102, and operates to store information within, and retrieve information from, database 104. The term “database” is used herein broadly to refer to an indexed store of data, whether structured or not, including without limitation relational databases and document databases. Web server 106 hosts one or more Internet web sites and/or Application Programming Interfaces (APIs) enabling outside user interaction with, amongst other things, application logic 102 and database 104. Messaging server 108 enables messaging, such as mobile network messaging service (e.g. SMS or MMS), email, or application notifications, between server 100 and user devices 120.

While depicted in the schematic block diagram of FIG. 1 as a block element with limited sub elements, as known in the art of modern web applications and network services, server 100 may be implemented in a variety of ways, including in a distributed computing environment where tasks are performed by remote processing devices that are linked through a communications network. In a distributed computing environment, program modules may be located in both local and remote computer storage media including memory storage devices. That said, the implementation of server 100 will typically include, at some level, one or more physical servers, at least one of the physical servers having one or more microprocessors and digital memory for, inter alia, storing instructions which, when executed by the processor, cause the server to perform methods and operations described herein.

In some cases, relational and other databases may perform aspects of such functionality, for example as a database management system which stores data related to the services and individuals using the service. Examples of databases include the MySQL Database Server, ORACLE Database Server by ORACLE Corp. of Redwood Shores, Calif., the PostreSQL Database Server by PostreSQL Global Development Group of Berkeley, Calif., or the DB2 Database Server offered by IBM. In some cases, distributed storage and compute resources may also be utilized, such as Hadoop, Apache Hive and Apache Cassandra.

Typically, server 100 interacts with user devices 120 to render a user interface, enabling communication of information to users of devices 120 and interaction between user devices 120 and server 100. Examples of user interfaces may include, inter alia, a mobile app graphical user interface rendered on a touch-sensitive display screen of a smartphone; or a web application rendered on web browser software running on a personal computer equipped with a keyboard and mouse. These and other embodiments facilitate implementation of methods and systems described herein.

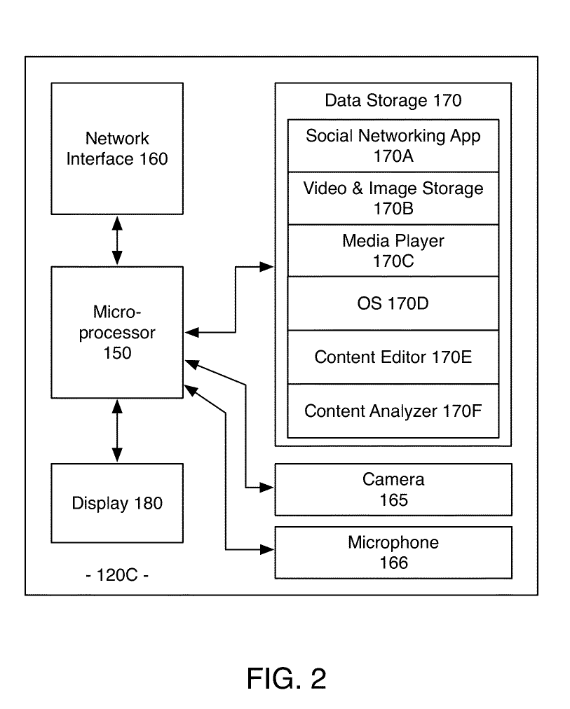

FIG. 2 is a schematic block diagram of an exemplary user device, smart phone 120C. Smart phone 120C includes microprocessor 150. Microprocessor 150 is configured to transfer data back and forth with data storage 170. Data storage 170 includes, inter alia, social networking application 170A, video and image storage 170B, media player 170C, operating system software 170D, content editor 170E and content analyzer application 170F. Social networking application 170A enables interaction between user device 120C and a social networking service, and may be implemented via, e.g., a locally-installed application and/or a web application implemented using web browser software.

Video and image storage 170B stores digital video and image content, such as profile pictures and profile videos. Media player 170C contains instructions that can be executed by microprocessor 150 to render media content on display 180, such as video clips and images. Operating system software 170D contains instructions that can be executed by microprocessor 150 to implement a computing device operating system. Content editor 170E contains instructions that can be executed by microprocessor 150 to enable a user to interactively modify content including digital images and/or video stored within video and image storage 170B. Content analyzer 170F can be executed by microprocessor 150 to analyze the emotional content of media, such as video or images, automatically. An emotion is a person's state of mind and may be associated with instinctive responses derived from one's circumstances, mood or relationships with others. Examples of the emotional content include, but are not limited to, anger, frustration, happiness, joy and fear.

Device 120C further includes digital camera 165, capable of recording digital images and digital video content within video and image storage 170B. Network interface 160 enables data communications with external networks, and may include common communication mechanisms including a cellular modem, Bluetooth interface and/or wireless Ethernet interface. Touchscreen display 180 enables user interaction with device 120C.

It should be appreciated by those of ordinary skill in the art that FIGS. 1 and 2 depict the various computing devices and environments in a simplified manner for purposes of clarity, and practical embodiments may include additional components and suitably configured processing logic to support known or conventional operations and functionality not described in detail herein.

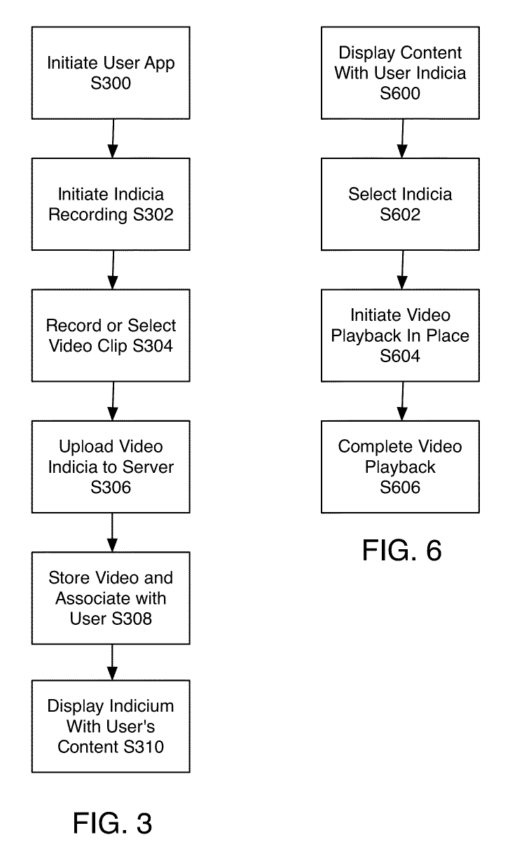

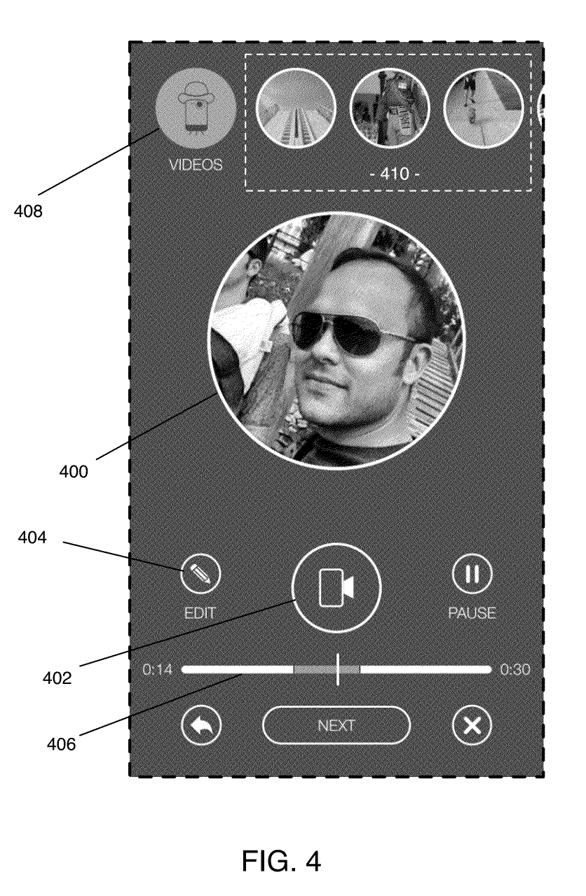

FIG. 3 is a flow chart of a process for generating video-based user indicia for a digital communication service. The process of FIG. 3 can be implemented by devices such as that of FIG. 2, and/or in computing environments such as that of FIG. 1. FIG. 4 is an exemplary graphical user interface that can be implemented on the mobile device of FIG. 2, facilitating portions of the process of FIG. 3.

In an exemplary operation, a user initiates a communication service application (such as a social networking app 170A or a messaging app) on mobile device 120C by interacting with display 180 (step S300). After creating an account and/or logging into the service, the user further initiates an indicia recording component (step S302). The indicia recording component preferably enables direct recording of video content, preferably including associated audio, via camera 165 and associated hardware, firmware and software provided by mobile device 120C.

FIG. 4 illustrates a user interface that can be rendered on display 180 during operation of the indicia recording component. Region 400 provides a live preview of content presently available for recording by camera 165. Record button icon 402 acts to start and stop recording of video and audio content by camera 165 and microphone 166, respectively. Selection of icon 404 provides the user with video and/or audio editing tools that may be utilized to modify recorded audiovisual content. Playback control bar 406 provides a user with control over the location within a recorded video clip for content insertion or playback.

In step S304, a user records or selects a video clip for use as a profile video user indicium. The user can record video using mobile device 120C and camera 165 by operation of various controls implemented by the indicia recording component, including those of FIG. 4. Alternatively, a user can preferably select a previously-recorded video clip for use as a user indicium. Specifically, icon 408 activates region 410, providing visual representation of previously-recorded videos. In some embodiments, previously-recorded videos displayed within region 410 include video clips stored within video and image storage 170B of mobile device 120C. In some embodiments, previously-recorded videos displayed within region 410 include video clips stored by server 100 or another network-connected data storage service. A user can select one of video icons 410 to choose a video clip. The selected clip then populates within preview region 400 and playback control bar 406, preferably enabling editing or supplementation of the selected clip by the user. In some embodiments, editing mechanisms may include tools to stitch together multiple video clips (recorded or prerecorded), and/or add music or other audio content to video clips.

The profile video selected or prepared by the indicia recording component is preferably stored locally within storage 170B, and also uploaded from user device 120 to server 100 via network 110 (step S306). The indicia clip may be stored within database 104 and associated with the user's account (step S308).

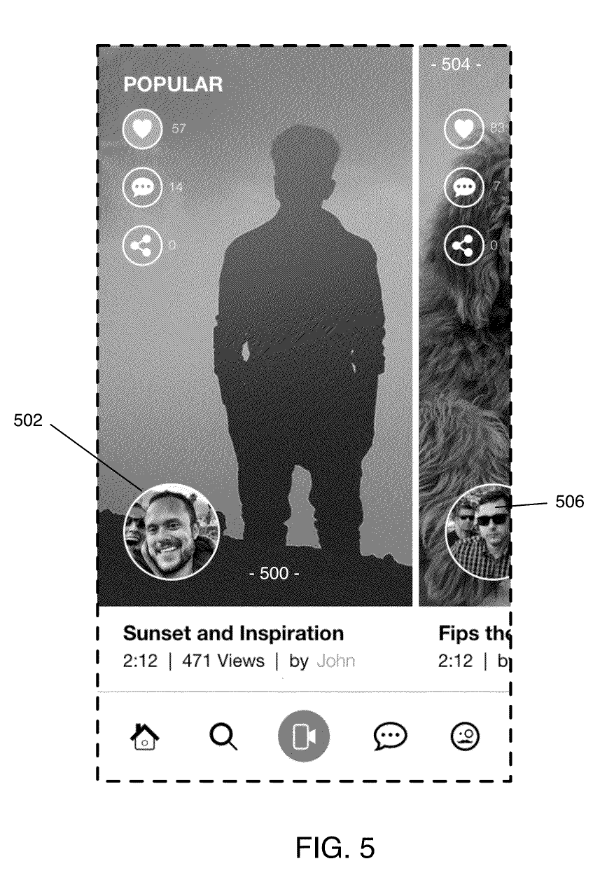

Once associated with a user, video-based user indicia may be displayed in connection with content items generated by or associated with that user (step S310), including use cases for which static profile images have previously been used in communication and social network services. FIG. 5 illustrates such an application, in a social media service enabling sharing of video content.

Specifically, FIG. 5 is an exemplary user interface for a video content gallery view, via which a viewer can browse video content contributed by other users. Pane 500 is a preview of video content contributed by a first user associated with user indicium 502; indicium 502 is overlaid on pane 500 to provide an indication of origin for other users browsing the content. Similarly, pane 504 is a preview of video content contributed by a second user associated with user indicium 506. While indicia 502 and 506 are circular in format, in other embodiments, video-based user profile indicia may be square, rectangular or any other shape. However, in embodiments in which user indicia may be displayed proximate traditional media content having a rectangular or square aspect ratio, such as a social media site for sharing photos or video, use of a circular user indicia may provide a visual cue that helps users more readily distinguish user indicia from shared content.

In some embodiments, a user indicium, such as indicia 502 and 506, is displayed initially as a static image that is a frame from a video clip. In some embodiments, the static image representation of the user indicium will be the initial frame of the video clip. In other embodiments, a user can select any frame within a video clip for use as a static representation of the video. In yet other embodiments, a user may be permitted to separately upload a still image that is associated with the video clip for static display, but which may or may not be extracted from the video clip.

FIG. 6 illustrates a process via which video-based user indicia can be utilized as an indicator of origin for user-generated and/or user-associated content. In step S600, a user may navigate through user-generated and user-associated content. For example, in the embodiment of FIG. 5, a user can scroll through video preview panes arranged horizontally adjacent one another, while overlaid user indicia provide a quick, visual reference point for source of origin of each content piece. Preferably, the user indicia are displayed statically until selection by a user (e.g. paused on a selected frame of the associated video clip). In step S602, the user can select a user indicium using user device 120, which selection is communicated to server 100. In the embodiment of FIG. 5, for example, a user can select indicium 502 by touching the region in which indicium 502 is rendered on a touchscreen display. In step S604, server 100 interacts with user device 120 to initiate playback of video content associated with the selected user indicium. For example, the underlying video clip may be downloaded from server 100 to device 120 upon selection of the user indicium 502, with playback initiated upon download.

Preferably, video content associated with indicium 502 is promptly played back in place, within region 502. In some embodiments, a visual playback indicator may be implemented to provide an indication to the viewer of the playback progress within the displayed video. Because user indicia may appear in a wide variety of locations on a display screen during dynamic navigation of user-generated and user-associated content, and in fact may move on the display screen if the user scrolls through content during playback, it may be desirable to implement a playback indicator mechanism that is largely independent of the location in which the indicia are displayed and the nature of other content rendered on the screen, yet still readily associated by a viewer with the user indicium video undergoing playback—all in an environment where multiple content items (even multiple video content items) may be rendered on a display simultaneously. More specifically, it may be desirable to implement a video playback progress indicator that is integrated within a user indicium frame.

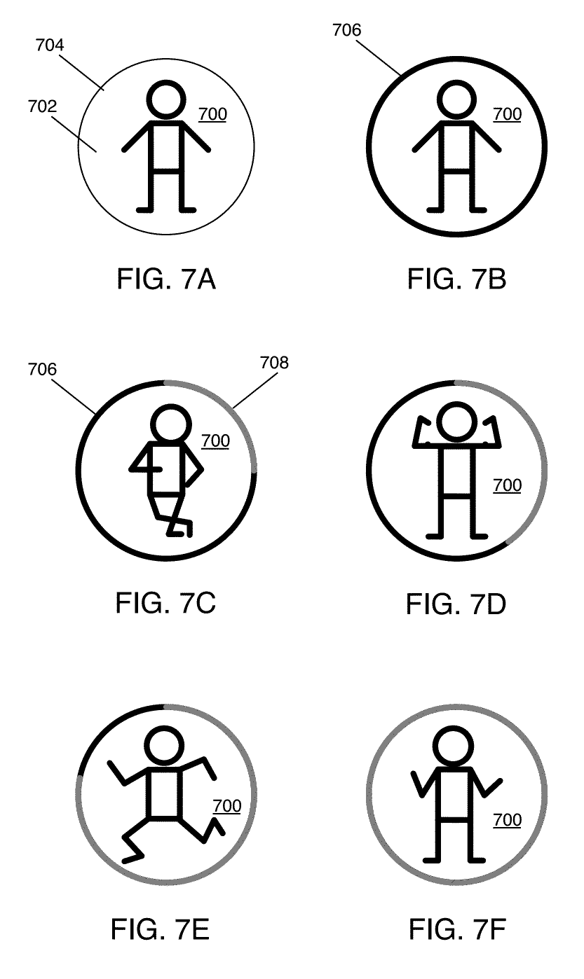

FIG. 7 illustrates an exemplary embodiment of such a playback indicator mechanism for video-based user indicia, in which the progress indicator is integrated within the user indicium. Specifically, in the embodiment of FIG. 7, a progress bar is rendered around the perimeter of an indicium frame. FIG. 7A illustrates user indicium 700 in a static state; in some embodiments, the static state of FIG. 7A may be displayed by default proximate user-generated or user-associated content. User indicium 700 comprises content region 702, circumscribed by border 704. FIG. 7B illustrates user indicium 700 as rendered upon selection of indicium 700 by a user, such as by tapping region 702 on a mobile device touchscreen display. Border 706 may be rendered in a contrasting weight or color, to help convey the initiation of playback of video associated with the selected user indicium.

FIG. 7C illustrates user indicium 700 in a state of partial playback completion. As playback progresses, a contrasting-color segment 708 initiates from a top, center position on border 706 and progresses counterclockwise around border 706. The relative proportions of border segment 706 and contrasting border segment 708 are reflective of the proportion of the video associated with the user indicium for which playback has completed. Thus, FIG. 7C illustrates a state in which playback of user indicium video 700 is approximately 25% complete. FIG. 7D illustrates a subsequent state of playback for user indicium video 700, in which playback is approximately 40% complete. FIG. 7E illustrates a further subsequent state of playback for user indicium video 700, in which playback is approximately 75% complete. FIG. 7F illustrates a state of playback for user indicium video 700, at which point playback has been completed. In some embodiments, following completion of playback, indicium 700 returns to a steady state of FIG. 7A, unless or until playback is reinitiated. In some embodiments, playback of profile video utilized as a user indicium may continue in a looped fashion unless paused by the user (e.g. by tapping or clicking again the user indicia).

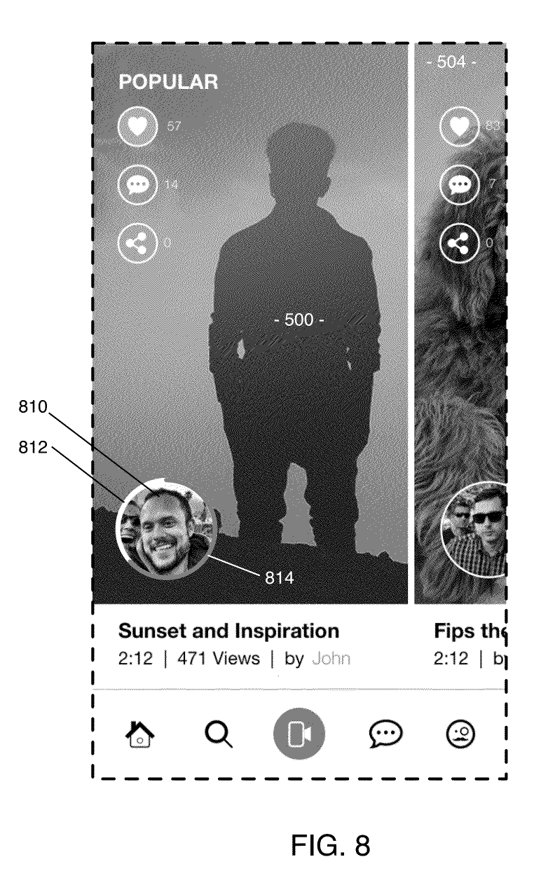

FIG. 8 illustrates a user interface in which the playback indicator mechanism of FIG. 7 is implemented for playback-in-place of user profile video. User indicium 810 is illustrated on user-generated content 500 during mid-playback of an associated profile video. Enhanced video frame 812 indicates playback operation. The length of playback progress indicator 814 (i.e. the portion of frame 812 that is overlapped) indicates the proportion of video playback that has been completed.

In some embodiments, it may be desirable for playback of profile video to be initiated automatically within a user indicium. For example, playback may be initiated automatically when the user indicium is rendered on a user's display screen. Where playback is initiated automatically, in some embodiments, automatic playback will include sound. In other embodiments, automatically-initiated playback will not include playback of audio content. In some embodiments, automatically-initiated playback of profile video content within a user indicium will exclude audio content unless and until a viewing user takes an action to initiate audio playback. Preferably, a user can tap, click or otherwise select a user indicium undergoing automatic profile video playback in order to further initiate playback of audio content associated with the video. In some embodiments in which playback of audio content is initiated by user action, further user action may cause playback of audio content to stop, effectively serving to “mute” the associated audio content. Repeatedly tapping or otherwise selecting the user indicium may toggle playback of audio content on and off.

In other embodiments, playback may be initiated upon satisfaction of a playback criterion, such as scrolling of a user indicium into a viewable area of a display screen. In some embodiments, playback may be paused or terminated by re-selection (e.g. tapping or clicking of a corresponding touchscreen display area) of a user indicium in mid-playback. In some embodiments, playback may be paused or terminated in response to other conditions, such as scrolling a user indicium off a visible portion of a display screen.

Preferably, video clips serving as user indicia are less than one minute in length, thereby facilitating casual playback. The user indicium video may portray the user's face or other content that is uniquely associated with the user, although in some embodiments, any media content can be used.

In some embodiments, the user indicium video incorporates sound content, which may be recorded during video recordation, added later, or both. For example, in a social media service distributing user generated content, a profile video may feature a user saying “Hello! Subscribe to my channel!” and/or making a friendly gesture. In other embodiments, the video may be silent and include only visual content.

In some embodiments, a user indicium video may include sound content which is played conditionally. For example, playback of the visual portion of a user indicium video may be initiated automatically, when the user indicium scrolls into view on a user's device screen; but playback of associated audio content may be withheld until the user affirmatively selects a user indicium by, e.g., tapping a region of a device display screen on which a user indicium video is portrayed.

FIG. 11 illustrates an exemplary process for use of video-based user indicia in a social networking service mobile application, as implemented on a mobile device such as that of FIG. 2. In the exemplary operation of FIG. 11, the profile video content is displayed in a looped fashion. Moreover, the looping video content is initiated automatically upon or prior to rendering of a user indicium on a device display, without audio content; and audio content is started and stopped (i.e. toggled) when the viewer taps the user indicium. Specifically, in step S1100, display content is rendered with video-based user indicia proximate user-generated or user-associated content. In step S1110, playback of profile video content within a user indicium is automatically initiated, without playback of audio content (i.e. audio content is muted), upon display of the user indicium to a viewing user. In step S1120, a determination is made as to whether the viewing user taps a display region in which the user indicium is rendered. If not, a further determination is made as to whether the user indicium remains displayed (step S1125). In some embodiments, the criteria for whether the user indicium remains displayed may comprise a determination of whether at least part of the user indicium remains rendered within the viewable display rendered by the mobile application. In other embodiments, alternative criteria for whether the user indicium remains active may be utilized, such as whether the indicium has moved outside the viewable display area by a predetermined number of pixels or for a predetermined period of time. In any case, if the user indicium is considered no longer displayed in step S1125, rendering of the profile video stops. If the user indicium continues to be displayed in step S1125, the process returns to step S1120 to continue monitoring for selection of the user indicium by the viewer.

When the user indicium is selected by the viewer in step S1120, playback of audio content is initiated (step S1130), i.e. audio content is unmuted. In step S1140, operation again monitors for tapping of the display region associated with the user indicium. If the user indicium is tapped, playback of audio content is muted (step S1150) and operation returns to step S1125. If not, in step S1160 a determination is made as to whether the user indicium continues to be displayed (analogous to step S1125). If not, operation stops. If so, operation returns to step S1140.

The embodiment of FIG. 8 illustrates use of a profile video user indicium in a social media service based on video sharing. In such embodiments, it may be desirable to implement interdependencies between profile video playback and shared content playback. For example, in the embodiment of FIG. 8, a user may tap content video region 500 to initiate playback thereof, then subsequently tap user indicium 810 in the midst of playback of content video 500. In some such embodiments, playback of profile video 810 may alter playback of content video 500 during the period in which profile video 810 is also playing, such as by reducing the volume of audio associated with content video 500, by muting audio associated with content video 500, by darkening the appearance of video associated with content video 500, by blurring the appearance of video associated with content video 500, by pausing playback of content video 500, or by combinations of multiple such alterations. Such effects and interdependencies may assist in reducing user confusion or attention conflict between simultaneously-playing content rendered on a user display.

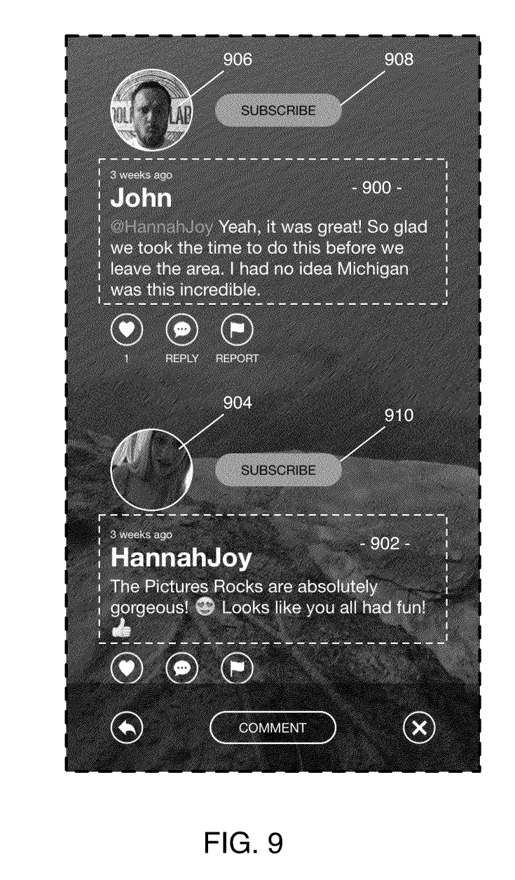

FIG. 9 illustrates another embodiment in which video-based user profile indicia are utilized in association with user-generated content. Content comment 902 is submitted by a user associated with user indicium 904; thus, user indicium 904 is displayed proximate comment content 902 and serves as a designator of origin for that comment. Comment 900 is responsive to comment 902, and submitted by a user associated with user indicium 906; accordingly, user indicium 906 is displayed proximate comment content 900. In the display user interface of FIG. 9, user india 904 and 906 can each be selected by a viewer to initiate playback-in-place of associated video (optionally including audio) content.

By providing ready access to profile video content in-place with other content generated by or otherwise associated with the same user, the video profile may provide greater context and understanding of content source of origin. As a result, users may more readily identify content providers of interest to them during use of a social networking or communication service. This may, in turn, generate increased linking and network expansion amongst users, and a richer, stickier user experience.

In order to further maximize the role of video-based user profile indicia in encouraging user-to-user linking and social network expansion, it may be desirable to implement a one-click social network linking mechanism proximate the video-based profile user indicia. To the extent that viewing of a user profile video promotes interest in another user, the viewer could readily establish a link to the user of interest, such as initiating a Follow or Subscribe relationship. Such a mechanism is illustrated in the embodiment of FIG. 9. Subscribe button 908 is displayed proximate user indicium 906; and subscribe button 910 is displayed proximate user indicium 904. Thus, for example, a user finding comment 902 of interest can view, in place, profile video associated with user indicium 904 and, to the extent the associated user appears of interest to the viewer, select subscribe button 910 to be subsequently notified of content contributions by the user associated with indicium 904.

In some embodiments, a user may create a number of different profile videos for use in different scenarios. In some such embodiments, users may be able to maintain a gallery of profile videos, which may be stored preferably by server 100 (such as within database 104), and additionally or alternatively within a user device (such as within storage 170B). A gallery of user profile videos may be made public (such as being accessible to one or more other users, such as via a user profile page associated with the user) or maintained as private and accessible to only the associated user. In some embodiments, a user can select one of the multiple different profile videos as a default video to be utilized as a user indicium in connection with new user-generated content. In such embodiments, a user may be presented with a selection mechanism at the point of content creation, for selecting one of multiple profile videos to be displayed proximate each new item of user-generated content. In some embodiments, a user may select one of multiple profile videos from their gallery, for display by the communication system in connection with all of that user's user-generated and user-associated content. In one embodiment, the user can select more than one such video to be used in combination (i.e. spliced together).

A user may create different videos to reflect different emotions or responses. Examples may include a video of the user making a welcoming gesture and saying something welcoming, a video of the user making an angry gesture and saying something angry, and so on. The user may then select an appropriate video when making a comment on a social media service—an angry video to match an angry comment, a happy video to match a happy comment, and so on. In such embodiments, profile videos may be used as a personalized alternative or supplement to emojis or emoticons, which are standardized images frequently used to convey emotion or opinion within user-generated content.

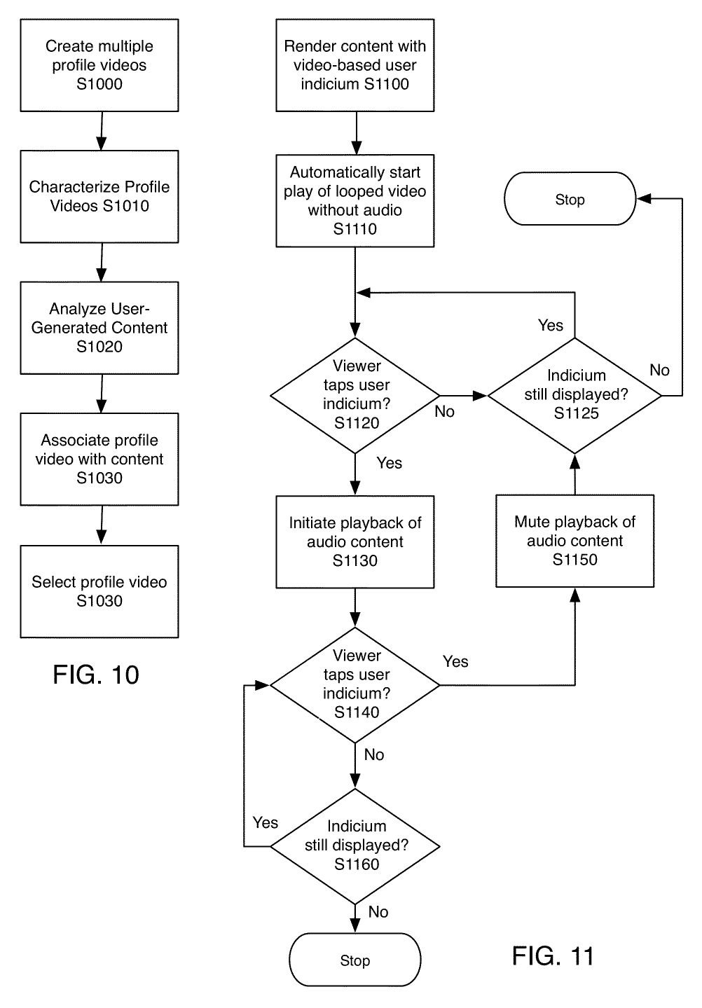

In some embodiments, a user's profile videos may be dynamically matched to user-generated content. FIG. 10 illustrates an embodiment of a dynamic profile video matching process. In step S1000, a user creates a plurality of profile videos with which they are associated. In some embodiments, the profile videos can be created via a mechanism analogous to that described in connection with FIG. 3 hereinabove. In step S1010, each profile video may be characterized. In some embodiments, profile videos may be characterized by the user with whom they are associated following uploading of the video, such as via text description or keyword association. In some embodiments, profile videos may be characterized at the time of upload, such as a social media service explicitly requesting upload of a video to be associated with each of multiple common emotions. In some embodiments, profile videos may be characterized in an automated manner, such as by a machine-learning based video content classification module and/or a natural language processing module configured to identify emotions, subject matter or the like.

In step S1020, an item of user-generated or user-associated content is analyzed by a characterization mechanism. In some embodiments in which profile videos are characterized in an automated manner, the characterization mechanism in step S1010 may share features or functionality with the characterization mechanism in step S1020, thereby encouraging identification of profile videos having common attributes with the user-generated or user-associated content. In some embodiments, content analyzer 170F can be executed within user device 120 (and optionally supplemented via distributed computing amongst user device 120 and network-connected servers) in order to characterize the user-generated content. Content analyzer 170F, when executed on microprocessor 150, may include one or more of a facial expression analyzer, speech-to-text conversion, natural language processing, color composition analysis, emotion extraction, subject identification or other content analysis mechanisms known in the art.

In step S1030, one of the multiple profile videos is associated with the user generated content analyzed in step S1020. In some embodiments, the association is performed using the results of characterization step S1010 and analysis step S1020. In some embodiments, the association is implemented to select a profile video having highest similarity in content to a particular item of user-generated or user-associated content. In some embodiments, the association is implemented to select a profile video most closely sharing common emotions with the user-generated and user-associated content. In step S1040, the user-generated or user-associated content is displayed proximate a user indicia comprising the profile video with which the content was associated in step S1030.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

1. A social networking system hosted on one or more servers communicating with a plurality of user devices via one or more digital communication networks, the servers having one or more processors and memory storing instructions which, when executed by the processors, cause the servers to perform a method comprising:
receiving a profile video clip from a first user device utilized by a first user;
associating the profile video clip with the first user; and
transmitting data to one or more of said user devices associated with viewers, the data enabling display by the viewers' user devices of a user indicium for the first user comprising the profile video clip.

2. The system of claim 1, in which the step of transmitting data to one or more of said user devices associated with viewers further comprises: transmitting data for displaying the profile video clip proximate content generated by, or associated with, the first user.

3. The system of claim 2, in which the step of transmitting data for displaying the profile video clip proximate content generated by, or associated with, the first user comprises:
transmitting data for initially displaying an image extracted from the profile video clip within a frame as the user indicium, the user indicium displayed proximate content generated by, or associated with, the first user;
receiving data indicative of a user having selected the user indicium; and
transmitting data for displaying the profile video clip within the frame.

4. The system of claim 3, in which the profile video clip comprises video content and audio content; and the step of transmitting data for displaying the profile video clip within the frame further comprises transmitting data for rendering the audio content.

5. The system of claim 2, in which the profile video clip comprises video content and audio content; and the step of transmitting data for displaying the profile video clip proximate content generated by, or associated with, the first user comprises:
transmitting data for initially displaying the profile video clip video content, without audio, within a frame proximate content generated by, or associated with, the first user;
receiving data indicative of a user having selected the user indicium; and
transmitting data for playback of the profile video clip audio content.

6. The system of claim 2, in which the profile video clip comprises video content and audio content; and the step of transmitting data for displaying the profile video clip proximate content generated by, or associated with, the first user comprises:
transmitting data for initially displaying the profile video clip video content, without audio, within a frame proximate content generated by, or associated with, the first user;
receiving data indicative of a user having selected the user indicium; and
toggling the playback of the profile video clip audio content.

7. The system of claim 2, in which the step of transmitting data for displaying the profile video clip proximate content generated by, or associated with, the first user comprises:
transmitting data for displaying the profile video clip in a looped fashion proximate content generated by, or associated with, the first user;
receiving data indicative of a user having selected a region on a user device display proximate the user indicium; and
toggling the playback of the profile video clip audio content.

8. The system of claim 3, in which the step of transmitting data for displaying the profile video clip within the frame comprises: initiating the rendering, on a user device, of a video playback progress indicator integrated with the user indicium.

9. The system of claim 8, in which the video playback progress indicator comprises a progress bar around the perimeter of the user indicium.

10. The system of claim 9, in which the user indicium is circular in shape.

11. The system of claim 2, in which the method further comprises:
receiving one or more additional video clips from the first user, the servers associating a plurality of video clips with the first user; and
in response to a request from the first user, using one of the plurality of video clips as the profile video clip.

12. A method for displaying content items in a social networking service, the method comprising:
specifying, by each of a plurality of users of the social networking service, a video clip for association with the user as a profile video;
transmitting social media content for display on user devices, the social media content comprising:
a plurality of content items, each content item associated with a user; and
for each content item, content from the profile video of the user with whom the content item is associated.

13. The method of claim 12, in which the content from the profile video is rendered as looped video.

14. The method of claim 12, in which the content from the profile video is rendered as a user indicia proximate each content item.

15. The method of claim 14, in which the social media content further comprises a playback progress indicator for each profile video undergoing playback.

16. The method of claim 15, in which the playback progress indicators comprise progress bars rendered around the perimeter of the profile videos.

17. The method of claim 16, further comprising circular frames within which the profile videos are rendered.

18. The method of claim 12, in which the content from the profile video of each user with whom a content item is associated comprises video content and audio content; and in which the profile video content is initially rendered on a user device with muted audio content; the profile video configured for playback of audio content in response to selection by a user of the profile video.

19. The method of claim 18, in which selection by a user of the profile video is accomplished by tapping a mobile device display area at which the profile video is rendered.

20. The method of claim 12, in which the content from the profile video of each user with whom a content item is associated comprises video content and audio content; and in which the profile video content is initially transmitted for playback without audio, playback of audio content being toggled via selection by a user of the profile video during playback.
